(19) United States
(12) Patent Application Publication
(10) Pub. No.: US 2025/0001346 A1
(43) Pub. Date: Jan. 2, 2025

(54) Air Filter

(71) Applicant: Metalmark Innovations, PBC, Cambridge, MA (US)

(72) Inventors: Sissi LIU, Arlington, MA (US); Elijah SHIRMAN, Winchester, MA (US); Tanya SHIRMAN, Winchester, MA (US)

(73) Assignee: Metalmark Innovations, PBC, Cambridge, MA (US)

(21) Appl. No.: 18/704,788

(22) PCT Filed: Oct. 25, 2022
(86) PCT No.: PCT/US2022/047736

§ 371 Date: Apr. 25, 2024

Related U.S. Application Data
(60) Provisional application No. 63/271,381, filed on Oct. 25, 2021.

(51) Int. Cl. B01D 46/82; B01D 39/20; B01D 46/00; B01D 46/52; B01D 46/62

(52) U.S. Cl. CPC B01D 46/82; B01D 39/2017; B01D 46/0028; B01D 46/521; B01D 46/62; B01D 2239/0258; B01D 2239/0471; B01D 2239/065; B01D 2258/06

(57) ABSTRACT

An air filter comprises a filter element that includes a proximal surface configured to receive a flow of air; is configured to remove a set of pollutants from the received flow of air; and includes a distal surface configured to allow passage of the flow of air after removal of the set of pollutants. The air filter further comprises a first activation element that is in contact with a first activated area located on the proximal surface of the filter element; and is configured to activate the first activated area; and also comprises a second activation element that is in contact with a second activated area located on the distal surface of the filter element; and is configured to activate the second activated area. In some embodiments, the air filter further comprises a controller configured to independently control operations of the first activation element and the second activation element.

### RELATED APPLICATION(S)

This application claims the benefit of priority in U.S. provisional application No. 63/271,381 filed Oct. 25, 2021, and entitled “Air Decontamination and Purification Apparatus,” the entire content of which is incorporated herein by reference.

### TECHNICAL FIELD

The present disclosure, generally, relates to an air filter for filtering air, more particularly, the present disclosure relates to an air filter configured for renewal to remove/desorb pollutants from at least one filter element.

### BACKGROUND

There are various indoor air purification devices currently on the market. Some emerging technologies for outdoor air quality improvement have also been introduced. These are based on technologies including: 1) mechanical filtration for the removal of airborne particulates (e.g., pleated filters, HEPA); 2) sorption for removal of certain gaseous molecules and odors (e.g., activated carbon); 3) ionization and electrostatic attraction of particulates; and 4) photocatalytic and plasma-based removal of pollutants. In practice, all the aforementioned technologies have been found to provide varying degrees of limited efficiency in purifying air from particulate matter, viruses, and other pathogenic microorganisms, and in removal of gaseous and fine particulate pollutants. These technologies may also release trapped pollutants or even generate hazardous by-products. In addition, filter-based systems require increased maintenance time and frequent filter replacements.

Accordingly, there is a need for improved air purification devices, which may be efficiently employed in a variety of environments, such as buildings, aircrafts, vehicles, water vessels, outdoors, etc.

### SUMMARY

In some embodiments, the techniques described herein relate to an air filter including: a first filter element, wherein the first filter element: includes a first proximal surface configured to receive a flow of air; is configured to remove a first set of pollutants from the received flow of air; and includes a first distal surface configured to allow passage of the flow of air after removal of the first set of pollutants; a second filter element, wherein the second filter element: includes a second proximal surface configured to receive at least a portion of the flow of air passed through the first distal surface of the first filter element; is configured to remove a second set of pollutants from the received flow of air; and includes a second distal surface configured to allow passage of the flow of air after removal of the second set of pollutants; a first activation element, wherein the first activation element: is in contact with a first activated area located on the first proximal surface of the first filter element; and is configured to activate the first activated area; and a second activation element, wherein the second activation element: is in contact with a second activated area located on the second distal surface of the second filter element; and is configured to activate the second activated area.

In some embodiments, the techniques described herein relate to an air filter, further including a third activation element wherein: the third activation element includes a third proximal surface that is in contact with the first distal surface; and the third activation element includes a third distal surface that is in contact with the second proximal surface.

In some embodiments, the techniques described herein relate to an air filter, wherein: the first filter element has a pleated form; the first proximal surface includes a first plurality of proximal peaks; and the first activation element is in contact with the first plurality of proximal peaks.

In some embodiments, the techniques described herein relate to an air filter, wherein: the second filter element has a pleated form; the second proximal surface includes a second plurality of proximal peaks; and the first activation element is in contact with the second plurality of proximal peaks.

In some embodiments, the techniques described herein relate to an air filter, wherein: the second filter element has a pleated form; the second distal surface includes a second plurality of distal peaks; and the second activation element is in contact with the second plurality of distal peaks.

In some embodiments, the techniques described herein relate to an air filter, wherein: the first filter element has a pleated form; the first distal surface includes a first plurality of distal peaks; and the second activation element is in contact with the first plurality of distal peaks.

In some embodiments, the techniques described herein relate to an air filter, wherein: at least one of the first filter element and the second filter element has a pleated form; and at least one of the first activation element and the second activation element has a pleated form.

In some embodiments, the techniques described herein relate to an air filter, further including a controller configured to control operations of at least one of the first activation element and the second activation element.

In some embodiments, the techniques described herein relate to an air filter, wherein the controller is further configured to perform an activating operation causing the at least one of the first activation element and the second activation element to activate the first activated area or the second activated area.

In some embodiments, the techniques described herein relate to an air filter, wherein the controller is configured to perform the activating operation during a renewal operation of the air filter for renewing the first filter element or the second filter element.

In some embodiments, the techniques described herein relate to an air filter, wherein the controller is configured to perform the activating operation during a filtering operation of the air filter for removing at least part of the first set of pollutants or the second set of pollutants.

In some embodiments, the techniques described herein relate to an air filter, wherein at least one of the first filter element and the second filter element includes a coating.

In some embodiments, the techniques described herein relate to an air filter, wherein the coating is a catalytic coating.

In some embodiments, the techniques described herein relate to an air filter, wherein the coating is a functional coating.

In some embodiments, the techniques described herein relate to an air filter, wherein the coating includes a plurality of active sites.

In some embodiments, the techniques described herein relate to an air filter, wherein the coating includes a plurality of nanoparticles.

In some embodiments, the techniques described herein relate to an air filter including: a filter element, wherein the filter element: includes a proximal surface configured to receive a flow of air; is configured to remove a set of pollutants from the received flow of air; and includes a distal surface configured to allow passage of the flow of air after removal of the set of pollutants; a first activation element, wherein the first activation element: is in contact with a first activated area located on the proximal surface of the filter element; and is configured to activate the first activated area; and a second activation element, wherein the second activation element: is in contact with a second activated area located on the distal surface of the filter element; and is configured to activate the second activated area.

In some embodiments, the techniques described herein relate to an air filter, wherein: the filter element has a pleated form; the proximal surface includes a first plurality of proximal peaks; and the first activation element is in contact with the first plurality of proximal peaks.

In some embodiments, the techniques described herein relate to an air filter, wherein: the distal surface includes a second plurality of distal peaks; and the second activation element is in contact with the second plurality of distal peaks.

In some embodiments, the techniques described herein relate to an air filter, wherein at least one of the first activation element and the second activation element has a pleated form.

In some embodiments, the techniques described herein relate to an air filter, further including a controller configured to control operations of at least one of the first activation element and the second activation element.

In some embodiments, the techniques described herein relate to an air filter, wherein the controller is further configured to perform an activating operation causing the at least one of the first activation element and the second activation element to activate the first activated area or the second activated area.

In some embodiments, the techniques described herein relate to an air filter, wherein the controller is configured to perform the activating operation during a renewal operation of the air filter for renewing the filter element.

In some embodiments, the techniques described herein relate to an air filter, wherein the controller is configured to perform the activating operation during a filtering operation of the air filter for removing at least part of the set of pollutants.

In some embodiments, the techniques described herein relate to an air filter, wherein the filter element includes a coating.

In some embodiments, the techniques described herein relate to an air filter, wherein the coating is a catalytic coating.

In some embodiments, the techniques described herein relate to an air filter, wherein the coating is a functional coating.

In some embodiments, the techniques described herein relate to an air filter, wherein the coating includes a plurality of active sites.

In some embodiments, the techniques described herein relate to an air filter, wherein the coating includes a plurality of nanoparticles.

In some embodiments, the techniques described herein relate to an air filter

including: a filter element, wherein the filter element: includes a proximal surface configured to receive a flow of air; is configured to remove a set of pollutants from the received flow of air; includes a distal surface configured to allow passage of the flow of air after removal of the set of pollutants; and at least one of the proximal surface and distal surface includes a coating; and an activation element, wherein the activation element is in contact with an activated area located on at least one of the proximal surface and the distal surface; and is configured to activate the first activated area;

In some embodiments, the techniques described herein relate to an air filter, wherein the coating is a catalytic coating.

In some embodiments, the techniques described herein relate to an air filter, wherein the coating is a functional coating.

In some embodiments, the techniques described herein relate to an air filter, wherein the coating includes a plurality of active sites.

In some embodiments, the techniques described herein relate to an air filter, wherein the coating includes a plurality of nanoparticles.

In some embodiments, the techniques described herein relate to an air filter including: at least one filter element having an input surface for receiving a flow of incoming air and an output surface through which filtered air exits the filter element; a plurality of discrete heating elements, at least one of which is configured to be in thermal contact with the at least one filter element; and a controller for independent control of the heating elements so as to allow operating said heating elements at independent temperatures.

In some embodiments, the techniques described herein relate to an air filter, further including at least one power supply operating under control of the controller and configured for supplying power to at least one of the heating elements.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 is a schematic diagram of an air filter 100 according to some embodiments.

FIG. 2 is a schematic diagram of an air filter 200 that includes pleated filter elements, according to some other embodiments.

FIG. 3 is a schematic diagram of an activator-filter construct 300 according to yet some other embodiments.

FIG. 4 is a schematic diagram of an air filter 400 according to another embodiment.

FIG. 5 is a schematic diagram of an air filter 500 utilizing one filter element according to some embodiments.

FIG. 6 schematically depicts an example of an implementation of a module 600 according to some embodiments.

### DETAILED DESCRIPTION

In some embodiments, the present disclosure provides an air filter having one or more filtering elements that are configured to capture at least one type of pollutants, if present in an incoming air flow, and one or more activation elements that may be activated to heat the incoming air or the filtering elements. Although the filter is shown as a rectangular filter, it may be appreciated that the filter may include any suitable shape, such as, cylindrical shape, known in the art, and the filter elements and the activation element may include corresponding shape/configuration.

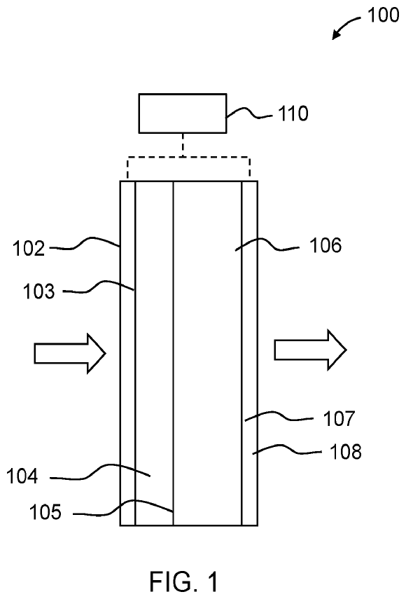

FIG. 1 is a schematic diagram of an air filter 100 according to some embodiments. Filter 100 includes a first activation element 102, a first filter element 104, a second filter element 106, a second activation element 108, and a controller module 110.

The air filter 100 is configured to filter air. More specifically, as further detailed below, during its operation, filter 100 may perform two types of operations, the filtering operation and the renewal operation. Filter 100 may perform these two operations intermittently such that filter 100 may halt one operation while performing the other operation. Alternatively, or in some embodiments, filter 100 may sometimes perform some part or all of the renewal operation without halting the filtering operation.

One or both of the activation elements may use one or more types of energy to activate one or both of the filters. In various embodiments, the type of energy may be the heat energy in which case the activation element may include a heating element. Other possible types of energy used by an activation element may be a radiation energy such as light, magnetic energy, etc. In what follows, some of the embodiments may be described as using the heat energy and one or more heating elements. However, it should be understood that other types of energy may also be used in addition or in place of the heat energy. Similarly, the activation element may include other types of energy generators such as light generators (e.g., one or more LEDs).

In filter 100 the first activation element 102 is arranged upstream of the first filter element 104, the second filter element 106 is arranged downstream of the first filter element 104, and the second activation element 108 is arranged downstream of the second filter element 106. In this disclosure, the terms proximal and distal are defined with respect to the direction of the air flow during the filtering operation such that the proximal section of an element is defined as the section that is located upstream with respect to the distal counterpart section of the same element.

In particular, in filter 100, first filter element 104 includes a first proximal surface 103 (here shown as the interface between first activation element 102 and first filter element 104). During the filtering operation of filter 100, the proximal surface of the first filter element is configured to receive the flow of the air that is being filtered and remove from it a first set of pollutants as further detailed below.

Moreover, in filter 100, first filter element 104 and second filter element 106 are in

contact through interface surface 105. More specifically, interface surface 105 is defined as the overlap area between a distal surface of first filter element 104 and a proximal surface of second filter element 106. During the filtering operation of filter 100, at least a portion of the air that is filtered by first filter element 104 may exit first filter element 104 through the distal surface of first filter element 104 and enter second filter element 106 through the proximal surface of second filter element 106.

During filtering operation of filter 100, second filter element 106 is configured to receive the portion of the air filtered by first filter element 104 and further filter it by removing a second set of pollutants as also further detailed below. Moreover, second filter element 106 includes a second distal surface 107 through which the air that is being further filtered by second filter element 106 exits the second filter element.

First activation element 102 is configured to be in contact with at least a portion of first proximal surface 103 (that portion also called hereinafter the first activated area, one example of which is a heated area) and activate (e.g., heat) that portion when filter 100 is in operation. Moreover, second activation element 108 is configured to be in contact with at least a portion of second distal surface 107 (that portion also called hereinafter the second activated area) and activate that portion when filter 100 is in operation. In some embodiments of filter 100 the first seated area and the second activated area may respectively be a flat portion (or all of) first proximal surface 103 and second distal surface 107.

Controller module 110 may be a module configured to control the operation of filter 100. More specifically, controller module 110 may control the timing of the operation of the filter and its renewal. During the operation, controller module 110 may operate filter 100 to receive the air flow and filter the air through its parts discussed above. Moreover, controller module 110 may be in communication with one or both of the activation elements, and control the timing and the temperature profile of the operation of the activation elements, as further detailed below. More specifically, controller module 110 may turn on one or both of the activation elements during the filtering operation, renewal operation, or parts of one or both of those operations. In various embodiments, the air filter system may also include a power supply module. The power supply module may receive signals from the controller module in order to supply power to the activation elements when needed.

In some embodiments, the controller module activates the activation elements independently. Moreover, in some embodiments, the controller module activates the activation elements based on different factors that indicate that activation is required for one or both of the filters. For example, the factors may include an accumulation of the pollutants on one or both of the filters, or an increased pressure drop across the filters. The factors may be determined based on the readings of one or more sensors such as pressure sensors, temperature sensors, particulate concentration sensors, etc. The controller module may be in communication with the one or more sensors to receive their readings and accordingly determine the timing for the activation of one or more of the activation elements.

In some embodiments, each of the filter elements 104 and 106 may be implemented as flat or pleated filters. In some embodiments, the pleated filters may include fiberglass. In some embodiments, one or more of the filter elements may be implemented as a high efficiency particulate air (HEPA) filter with high minimum efficiency reporting value (MERV) ratings. Although two filter elements 104, 106 arranged in series are shown and contemplated, it may be appreciated that the filter 100 may include any number of filters arranged in series.

In some embodiments, the first filter element 104 may be a pre-filter that is configured to capture and trap relatively larger pollutants. As such, in some embodiments, the first filter element 104 may remove at least a portion of organic pollutant compounds from the air entering filter 100. In some embodiments, to facilitate the thermal oxidation of certain organic pollutants, the first filter element 104 may be coated with one or more oxidation catalysts. Examples of the catalysts that may be used to coat the first filter element 104 may include, but are not limited to, platinum, rhodium, palladium, iridium, ruthenium, osmium, silver, gold, nickel, vanadium-based catalysts, other metal oxides, and ceramics. In some embodiments, the catalytic coating may include one or more precious metals. In some embodiments, the first filter element 104 may be made of, include, or be coated with any of fiberglass, polymer fibers, stainless steel, nickel alloy, Inconel, FeCrAl alloy, or a combination thereof.

In some embodiments, the first filter element 104 may be configured to target removal of a first set of pollutants such as particulates in the size range of 1 micron and larger, including PM1, PM2.5 and PM10. By way of example, the particles may include, but not limited to, bioaerosols and pathogens. Bioaerosols may include, for example, bacteria, viruses, fungi, algae, and dust mites. In addition, biological materials may include pollen, endotoxins, proteins, and animal excreta in the form of aerosols.

In some example embodiments, the first filter element 104 is configured to remove pollutants that may include at least some of black carbons (generally also referred to as soot), dust particles, airborne mineral particles, airborne metal particles, other non-volatile particulate matter, volatile and non-volatile aerosols, and the like.

The second filter element 106 (in some embodiments considered the primary filter) is configured to provide filtration of a second set of pollutants that may include at least a portion of pollutants that are not captured, trapped or destroyed by the first filter element 104. In some embodiments, the second filter element 106 is configured to capture and trap sub-micron pollutants contained in the air stream. For example, in some embodiments, such sub-micron pollutants may have a size (e.g., a maximum cross-sectional size) in a range of about 5 nanometers to about 1000 nanometers. In some embodiments, the second filter element 106 may also remove at least some of organic pollutants such as hydrocarbons, aromatic compounds, volatile organic compounds (VOCs), and the like.

In some embodiments, the second filter element 106 may be coated with catalytic or functional material. In some embodiments, the catalytic or functional coating may include a variety of materials or mixtures of materials. In some embodiments, the materials may include, such as, but not limited to, one or more metal oxides, metals (such as gold, palladium, platinum, silver, copper, rhodium, ruthenium, rhenium, titanium, osmium, iridium, iron, cobalt, or nickel, or a combination thereof), semiconductors (such as silicon, germanium, tin, silicon doped with group III or V elements, germanium doped with group III or V elements, tin doped with group III or V elements, or a combination thereof), a metal sulfide, a metal chalcogenide, a metal nitride, a metal pnictide and a combination thereof.

In some embodiments, the coating may include, such as, but not limited, one of silica, alumina, titania, zirconia, ceria, hafnia, vanadia, beryllia, noble metal oxides, platinum group metal oxides, titania, tin oxide, manganese oxide, copper oxide, molybdenum oxide, tungsten oxide, rhenium oxide, tantalum oxide, niobium oxide, chromium oxide, scandium oxide, yttria, lanthanum oxide, thorium oxide, uranium oxide, other rare earth oxides, or a combination thereof. In some embodiments, the coating may include a thickness in a range of about 1 to about 200 micrometers, e.g., in a range of about 10 micrometers to about 150 micrometers, or in a range of about 50 micrometers to about 100 micrometers.

In some scenarios, the coating may comprise biogenic materials such as biogenic silica-based microparticles, or diatomaceous earth. In some embodiments, the coating may include one or more organometallic complexes (such as, but not limited to, metal organic frameworks), inorganic polymers (such as, but not limited to, silicone), organometallic complexes, or combinations thereof, covalent, non-covalent and supramolecular polymers (such as, but not limited to, polystyrene, polyurethane, hydrogels, and organogels), natural materials, a protein- or polysaccharide-based material, silk fibroin, chitin, shellac, cellulose, chitosan, alginate, gelatin, or a mixture thereof, and mixtures thereof.

In some embodiments, the coating may be designed to be catalytically active, stimuli-responsive, chemically robust, degradable, or exhibit specific optical, thermal, mechanical, sorption, release, or acoustic properties. By way of example, such coatings may include catalytically active metal oxides, such as, but not limited to, titania, copper oxide, ceria, zirconia, manganese oxide, and nickel oxide. In certain scenarios, the coating may interact with light in a way that it becomes active toward pollutant treatment (e.g., photocatalysis, photothermal catalysis, or photoelectrocatalysis). In some embodiments, the composition of the coating may be modified to provide enhanced mechanical properties and robustness by utilizing mechanically robust materials such as alumina, tungsten oxide, and metal alloys. In some embodiments, the specific optical properties may be introduced through the design of porosity and pore ordering in the coating (e.g., photonic structures such as inverse opals).

In some embodiments, the coating may include one or more materials that facilitate/enhance the adsorption of bioaerosols, particulates, gaseous pollutants, and other pollutants. In some embodiments, such enhanced adsorption properties may be due to the presence of chemical functional groups on the surface of coating (e.g., amine or thiol), and the coating composition (e.g., metal oxides, silica, zeolites, activated carbon).

In some embodiments, the coating may exhibit sorption (both adsorption and absorption) properties including sorption of gases (e.g., VOCs, CO2, CO, ammonia and its derivatives), particulate matter and microorganisms (e.g., pathogens, such as bacteria, viruses, etc.).

In some embodiments, the coating may exhibit both sorption and catalytic activity. For example, the coating may include one or more metal oxides with surface properties designed with increased affinity toward certain pollutants (hydroxylated surface or surface with amine functions to improve the adsorption of polar molecule such as formaldehyde or alcohol or hydrophilic particle) and elemental composition with catalytic activity toward treatment of pollutants (e.g., nickel oxide, palladium oxide, mixed metal oxides).

In some embodiments, the functionality of the active sites may originate, at least partially, from the morphological features of the coating surface such as its roughness. For example, the coating surface may comprise one or more of spikes, bumps, or cavities in a representative size (e.g., height, length, diameter, etc.), ranging from about 1 nm to about 20 nm. In some embodiments, the functionality of the active sites may originate, at least partially, from the structural features of the coating surface such as, but not limited to, surface crystallinity, crystal grains size, and surface phase. In some embodiments, the functionality of the active sites may originate, at least partially, from the combination of surface structure and composition. In some such embodiments, the surface structure and the surface composition may synergistically cooperate to provide enhanced filtering results.

In some additional embodiments, the active sites may be located in a plurality of microscopic pores that are present in the coating that is disposed on a macroscopic substate, which in some cases may itself exhibit a (macroscopic) porous structure. In some embodiments, the microscopic pores of the coating may include a plurality of catalytic nanoparticles configured to chemically breaking down essential components of certain pollutants, e.g., one or more viral protein structures and hence lead to viral inactivation or weakening or destruction. In some embodiments, the localized active sites may be located at the interface of coating and the pore(s).

In some embodiments, the catalytic nanoparticles may include metal nanoparticles, such as, but not limited to, gold, silver, platinum, palladium, ruthenium, rhodium, cobalt, iron, nickel, osmium, iridium, rhenium, copper, chromium, tungsten, molybdenum, vanadium, niobium, tantalum, titanium, zirconium, hafnium, bimetals, metal alloys, metal compounds, such as, but not limited to, pnictides, hydroxides, binary and complex salts, including heteropolyacids and their derivatives or a combination thereof.

In some embodiments, the catalytic nanoparticles may include nanoparticles made of metal oxides, mixed metal oxides, or metal sulfide nanoparticles; some particular examples include vanadia, silica, alumina, titania, zirconia, hafnia, nickel oxide, cobalt oxide, tin oxide, manganese oxide, magnesium oxide, noble metal oxides, platinum group metal oxides, molybdenum oxides, tungsten oxides, rhenium oxides, tantalum oxide, niobium oxide, chromium oxides, scandium, yttrium, lanthanum, thorium, uranium oxides, other rare earth oxides, or a combination thereof.

In some embodiments, the catalytic nanoparticles may include semiconductor nanoparticles, such as, but not limited to, silicon or germanium, either pure or doped with elements or compounds of group III or V elements, or a combination thereof.

In some embodiments, an active site may include complex salts with alkali, alkali-earth, and group (III) metals or transition metal salts such as salts of nickel, copper, cobalt, manganese, magnesium, chromium, iron, platinum, tungsten, zinc, or other metals. In some example embodiments, an active site may include a metal cation, a metal oxide, organometallic complex or combination thereof. In some embodiments, an active site may include a biologically derived material, such as an enzyme or a protein.

In some embodiments, the coating may utilize metal oxides that promote physisorption of the bioaerosols and particulates and their breakage.

In some embodiments, the activation of catalytic/functional sites may be achieved through heat or light activation. For example, plasmonic nanoparticles may be responsive to certain wavelengths of the electromagnetic radiation (e.g., gold nanoparticles absorb strongly at ˜530 nm).

The first activation element 102 and the second activation element 106 are adapted to continuously or periodically activate at least one filter element, for example, the first filter element 104 and the second filter element 106, to renew at least one filter element, for example, the first filter element 104 and the second filter element 106. As shown, the first activation element 102 is disposed upstream of the first filter element 104 and contacting the first filter element 104, while the second activation element 108 is arranged downstream of the second filter element 106 and contacting the second filter element 106.

In various embodiments, renewing a filter may include the removal or elimination of some or all of entrapped pollutants. In some embodiments, renewing a filter may decrease the pressure drop of the filter. In some embodiments, this pressure drop may decrease by at least 10% after the renewal.

In some embodiments, one or more of the activation elements and the filter elements may have forms that are different from the flat Forms shown in air filter 100. For example, one or more of the activation elements or the filter elements may have a pleated form as further described below. Alternatively, in some embodiments, the filter elements may be in other shapes such as cylindrical, circular, or in a variety of other commonly available shapes.

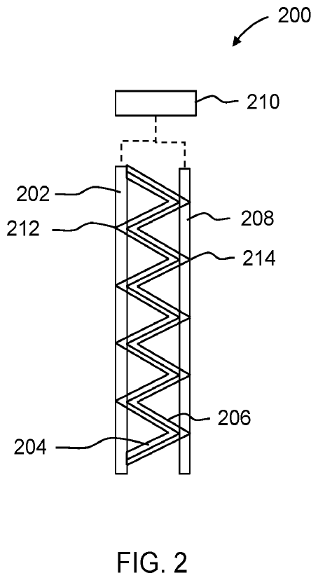

FIG. 2 is a schematic diagram of an air filter 200 that includes pleated filter elements, according to some other embodiments. Filter 200 includes a first activation element 202, a first filter element 204, a second filter element 206, a second activation element 208, and a controller 210. In particular, in air filter 200, the first filter element 204 and the second filter element 206 are in the pleated form, including proximal peaks 212 and distal peaks 214. More specifically, the proximal peaks of first filter element 204 may be located on the first proximal surface (that is, as defined above, the proximal surface of the first filter element); and the proximal peaks of second filter element 206 may be located on the second proximal surface (that is, as defined above, the proximal surface of the second filter element). Similarly, the distal peaks of the first filter element may be located on the first distal surface (that is, as defined above, the distal surface of the first filter element) and the distal peaks of the second filter element may be located on the second distal surface (that is, as defined above, the distal surface of the second filter element).

Moreover, first activation element 202 is in contact with one or more of the proximal peaks 212 of the pleated filter elements 204 or 206, while second activation element 208 is in contact with one or more of the distal peaks 214.

In some embodiments, the air filter 200 with the pleated filter elements may include one of the first or second activation elements. Moreover, in some embodiments, the air filter 200 may not include one of the first or second filter elements. Further, in various embodiments, the first or the second activation elements may contact the peaks of one or both filter elements. For example, the first activation element may be in contact with the proximal peaks of both of the first and the second filter elements, or only in contact with the proximal peaks of the first filter element. Similarly, the second activation element may be in contact with the distal peaks of both of the first and the second filter elements or only in contact with the distal peaks of the second filter element.

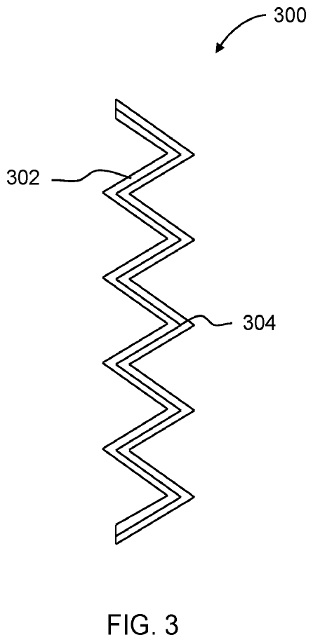

FIG. 3 is a schematic diagram of an activator-filter construct 300 according to yet some other embodiments. In various embodiments activator-filter construct 300 may be a section of an air filter similar to air filters 100 or 200, in which the combination of the first activation element and the first filter element is replaced with a construct similar to activator-filter construct 300. Alternatively, in some embodiments, the combination of both activation elements and both filter elements may be replaced with one or two constructs similar to activator-filter construct 300.

Activator-filter construct 300 includes a pleated filter element 304 and a pleated activation element 302, which follows the contours of pleated filter element 304. Therefore, unlike activation elements 202 or 208 in air filter 200, which were only in contact with the peaks of the filter elements, pleated activation element 302 is in contact with an extended length or the whole length of pleated filter element 304.

In some embodiments, the one or more of the activation elements may include one or more resistive activation elements, e.g., metal wires that may generate heat in response to application of an electric current thereto. For example, nichrome wires may be used as the resistive activation elements. In some embodiments, the metal wires or coils (e.g., nichrome wires, tungsten wires) may be housed within a heater housing, and in other embodiments, at least a portion of the metal wires may be exposed to the incident air stream. Although the activation elements are contemplated as the electric activation element having resistive wires, it may be envisioned that the activation elements may include a plurality of lights, for example LED strips for photocatalytic activation.

In some embodiments, one or more activation elements may be incorporated into the associated filter elements, for example, in the form of, for example, a metal mesh. In some such embodiments, the metal mesh structure may serve as an internal structural support or an external housing for the filter elements.

As the activation elements are configured to elevate the temperature of the associated filter elements at least some pollutants trapped on the first filter element may be desorbed, due to the heat generated from the first activation element such that the desorbed pollutants may subsequently be decomposed or oxidized while passing through the second filter element. Further, the first filter element may pyrolyze or catalytically oxidize organic compounds contained in the incident air stream or organic fraction of pollutants released from adsorbed pollutants.

By way of example, the first filter element or the second filter element is heated to about 150° C. or higher. The elevated temperature may activate catalysts, e.g., those incorporated (e.g., coated) on the second filter element or the first filter element. Alternatively, or additionally, the elevated temperature may facilitate thermal decomposition (e.g., pyrolysis) or thermal oxidation of organic compounds on the first filter element. Further, the elevated temperature may induce desorption of trapped pollutants from the first filter element, which may be subsequently decomposed or oxidized while passing through the second filter element.

In some embodiments, in use, the filter elements may be maintained at elevated

temperatures in the range of about 15° C. to about 500° C. In some embodiments, the structure may be maintained at temperatures of about 20° C., about 30°° C., about 40° C., about 50° C., about 60° C., about 70°° C., about 80° C., about 90°° C., about 100°° C., about 125°° C., about 150° C., about 175° C., about 200°° C., about 225°° C., about 250°° C., about 275° C., about 300° C., about 325° C., about 350° C., about 375° C., about 400° C., about 425°° C., about 450° C., or about 475° C. Such elevated temperatures may facilitate the treatment (e.g., inactivation) of one or more pollutants due to activation of the active sites or thermal contact of the inner surface of the macroscopic structure and the coating.

By way of example, the active sites may include metal nanoparticles including platinum group metals (e.g., Pd, Pt) which become catalytically active upon heating and induce oxidative damage to the surface of a pathogen within the incoming air stream and lead to its inactivation.

In some embodiments, the active components may be further designed to provide catalytic, photocatalytic, electrocatalytic, photonic, antimicrobial, light absorbing or emitting, stimuli responsiveness, adsorption, and desorption properties. The active sites may be introduced, for example, during the coating formation or through post modification of the coating.

In some embodiments, post modification may include chemical modification of the surface of porous coating with active components including nanoparticles, chemical compounds, complexes through attachment of these active components via covalent bonding, ionic bonding, van der Waals bonding, and a combination thereof.

In some embodiments, the active material may be introduced through physical vapor deposition, atomic layer deposition, evaporation, sputtering, wet chemical modification, wet processing, ion impregnation, and a combination thereof.

Further, the first filter element or the second filter element may be heated such that a desired temperature profile is achieved in the direction of flow of air through the filter 100. In various embodiments, a temperature profile may be defined as the vector direction of heat flow by conduction or convection.

The desired temperature profile may correspond to a level of deposition of the pollutants on the filter elements. For example, the desired temperature profile may correspond to the deposition of pollutants on the peaks, valleys, and sidewall of the filter elements to achieve an effective removal of the pollutants, from the filter elements and hence effective renewal of the filter elements.

In various embodiments, the controller may be configured to control the timing and temperature of one or more of the activation elements to achieve the desired temperature profile or renewal plan. In some embodiment, the controller is configured to control the activation elements such that a desired temperature profile is achieved in a direction of the flow of the air through the filter elements. The temperature profile may be selected based on a known distribution of the accumulation of the pollutants along the peak, the valley and the walls of the pleated filters to effectively renew or decompose the pollutants accumulated at various location of the filter elements.

In some embodiments, the filter may include one or more pollutant sensors (not shown) to determine the type of the pollutants accumulated on the filter elements and distribution of the pollutants deposited on the filter elements in a direction of the flow of the air. Based on the distribution of the pollutants or the type of pollutants, the controller may be configured to control the first activation element or the second activation element to achieve a desired temperature profile on the filter elements that may affectively remove the pollutants from the filter elements and renew the filter elements. To that end, the filter may include one or more temperature sensors to measure the temperature at various locations of each of the filter elements. Based on the measurements, the controller may control the activation elements. In some embodiments, the temperature sensors may be thermocouples.

In some embodiments, the controller may start or initiate the activation of the filter elements periodically. In such a case, the controller may start the activation elements after a predefined interval and may operate the activation elements for predetermined duration. Alternatively, the controller may operate the activation elements based on the data of deposition of the pollutants received from various sensors, and keep operating and controlling the activation elements until the level of pollutants deposited on the first filter element or the second filter element has reached below a predefined level. In some embodiments, the predefined level for the first filter element may be different from the predefined level for the second filter element. In some embodiments, the filter may include a power source to provide power to the first activation element and the second activation element.

Additionally, or optionally, the filter may include a sorption material (for example, in the form of a layer) that may be arranged downstream of the second filter element. The sorption material may be configured for absorbing (or fixating) gas phase pollutants or the pollutants that are vaporized by the activated first filter element or the second filter element. By way of example, the sorption material may be configured to remove at least some of gas-phase or vaporized species such as carbon monoxide, carbon dioxide, sulfur dioxide, nitrogen oxides, hydrocarbons, aromatic compounds, VOCs, and the like. In some embodiments, the sorption material may include activated carbon or charcoal.

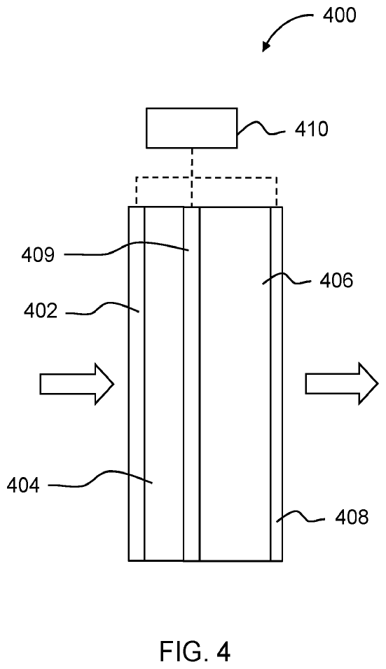

Some embodiments may include additional activation elements for activating other interfaces, such as the interface between the first and second filter elements, FIG. 4 is a schematic diagram of an air filter 400 according to one such embodiment. Filter 400 includes a first activation element 402, a first filter element 404, a second filter element 406, a second activation element 408, a third activation element 409, and a controller 410.

The additional activation element (i.e., the third activation element 409) is arranged between the first filter element 404 and the second filter element 406. The controller 410 may be configured to control one or more of the first activation element 402, the second activation element 408, and the third activation element 409. Through these controls, controller 410 may be configured to control the temperature of one or both of the first filter element 404 and the second filter element 406 to achieve the renewal of the filter 400.

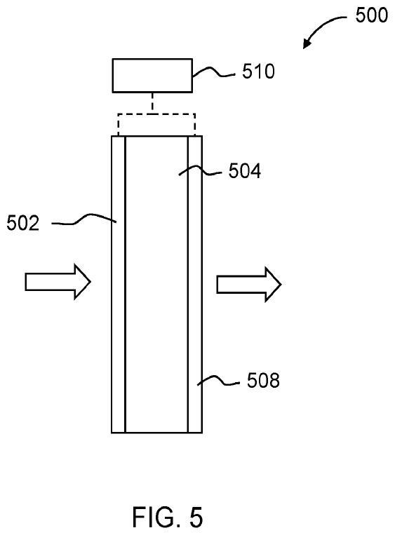

Alternatively, some embodiments may utilize fewer number of activation elements or filter elements. FIG. 5 is a schematic diagram of an air filter 500 utilizing one filter element according to some embodiments. Filter 500 includes a first activation element 502, a first filter element 504, a second activation element 508, and a controller 510. The controller 510 may be configured to control one or both of the first activation element 502 and the second activation element 508 to control the temperature of the first filter element 504 and to achieve the renewal of the filter 500. Although two activation elements are shown, it may be appreciated that one of the activation elements may be omitted from the filter.

In various embodiments, in an air filter with one filter element, such as air filter 500, the filter element, the first activation element, or the second activation element, may have different forms discussed earlier in relation to the above air filters with two filter elements. For example, the filter element may be in the pleated form. Moreover, when the filter element is in depleted form, one or both of the activation elements may have a flat form, as shown in FIG. 2, or a pleated form, as shown in FIG. 3.

The air filter may be used in an air conditioning unit, a room air filter unit, an HVAC (heating ventilation and air conditioning unit), an intake air assembly for an engine or automobile, or any other similar application for providing clean air.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

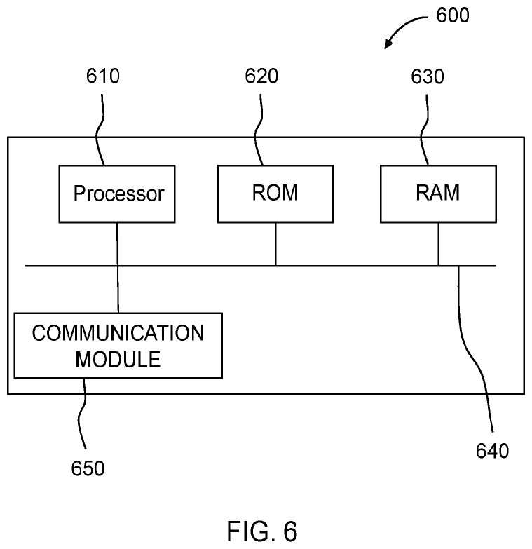

By way of example, FIG. 6 schematically depicts an example of an implementation of a module 600 according to some embodiments. Module 600 includes a processor 610 (e.g., a microprocessor), at least one permanent memory module (e.g., ROM 620), at least one transient memory module (e.g., RAM) 630, a bus 640, and a communication module 650.

Processor 610, ROM 620, and RAM 630 may be utilized to store and execute instructions performing the function of module 600. Moreover, bus 640 may allow communication between the processor and various other components of the controller. Communication module 650 may be configured to allow sending and receiving signals.

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other embodiments may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set may include one or more members and a subset of a set may include one or more than one, including all, members of the set. The disclosed systems, methods, and apparatus are not limited to any specific aspect

or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

1. An air filter comprising:
at least one filter element, wherein the at least one filter element:
includes a proximal surface configured to receive a flow of air;
is configured to remove a set of pollutants from the received flow of air; and
includes a distal surface configured to allow passage of the flow of air after removal of the set of pollutants;
a first activation element, wherein the first activation element:
is in contact with a first activated area located on the proximal surface of the at least one filter element; and
is configured to activate the first activated area; and
a second activation element, wherein the second activation element:
is in contact with a second activated area located on the distal surface of the at least one filter element; and
is configured to activate the second activated area.

2. The air filter of claim 1, further comprising a controller configured to independently control operations of the first activation element and the second activation element.

3. The air filter of claim 2, wherein the controller is further configured to perform an activating operation causing the first activation element to activate the first activated area at a first temperature and causing the second activation element to activate the second activated area at a second temperature that is independent of the first temperature.

4. The air filter of claim 3, wherein the controller is configured to perform the activating operation during a renewal operation of the air filter for renewing the at least one filter element.

5. The air filter of claim 3, wherein the controller is configured to perform the activating operation during a filtering operation of the air filter for removing at least part of the set of pollutants.

6. The air filter of claim 1, wherein:
the at least one filter element has a pleated form;
the proximal surface includes a first plurality of proximal peaks; and
the first activation element is in contact with the first plurality of proximal peaks.

7. The air filter of claim 6, wherein:
the distal surface includes a second plurality of distal peaks; and
the second activation element is in contact with the second plurality of distal peaks.

8. The air filter of claim 7, wherein at least one of the first activation element and the second activation element has a pleated form.

9. The air filter of claim 1, wherein the at least one filter element includes a coating.

10. The air filter of claim 9, wherein the coating is at least one of a catalytic coating and a functional coating.

11. (canceled)

12. The air filter of claim 9, wherein the coating includes a plurality of active sites.

13. The air filter of claim 9, wherein the coating includes a plurality of nanoparticles.

14. An air filter comprising:
a first filter element, wherein the first filter element:
includes a first proximal surface configured to receive a flow of air;
is configured to remove a first set of pollutants from the received flow of air; and
includes a first distal surface configured to allow passage of the flow of air after removal of the first set of pollutants;
a second filter element, wherein the second filter element:
includes a second proximal surface configured to receive at least a portion of the flow of air passed through the first distal surface of the first filter element;
is configured to remove a second set of pollutants from the received flow of air; and
includes a second distal surface configured to allow passage of the flow of air after removal of the second set of pollutants;
a first activation element, wherein the first activation element:
is in contact with a first activated area located on the first proximal surface of the first filter element; and
is configured to activate the first activated area; and
a second activation element, wherein the second activation element:
is in contact with a second activated area located on the second distal surface of the second filter element; and
is configured to activate the second activated area.

15. The air filter of claim 14, further comprising a controller configured to independently control operations of the first activation element and the second activation element.

16. The air filter of claim 15, wherein the controller is further configured to perform an activating operation causing the first activation element to activate the first activated area at a first temperature and causing the second activation element to activate the second activated area at a second temperature that is independent of the first temperature.

17. The air filter of claim 16, wherein the controller is configured to perform the activating operation during a renewal operation of the air filter for renewing the first filter element or the second filter element.

18. The air filter of claim 16, wherein the controller is configured to perform the activating operation during a filtering operation of the air filter for removing at least part of the first set of pollutants or the second set of pollutants.

19. The air filter of claim 14, further comprising a third activation element wherein:
the third activation element includes a third proximal surface that is in contact with the first distal surface; and
the third activation element includes a third distal surface that is in contact with the second proximal surface.

20. The air filter of claim 14, wherein:
the first filter element has a pleated form;
the first proximal surface includes a first plurality of proximal peaks; and
the first activation element is in contact with the first plurality of proximal peaks.

21. The air filter of claim 20, wherein:
the second filter element has a pleated form;
the second proximal surface includes a second plurality of proximal peaks; and
the first activation element is in contact with the second plurality of proximal peaks.

22. The air filter of claim 14, wherein:
the second filter element has a pleated form;
the second distal surface includes a second plurality of distal peaks; and
the second activation element is in contact with the second plurality of distal peaks.

23. (canceled)

24. The air filter of claim 14, wherein:
at least one of the first filter element and the second filter element has a pleated form; and
at least one of the first activation element and the second activation element has a pleated form.

25. The air filter of claim 14, wherein at least one of the first filter element and the second filter element includes a coating.

26. The air filter of claim 25, wherein the coating is at least one of a catalytic coating and a functional coating.

27. (canceled)

28. The air filter of claim 25, wherein the coating includes a plurality of active sites.

29. The air filter of claim 25, wherein the coating includes a plurality of nanoparticles.

30-36. (canceled)
